(19) United States
(12) Patent Application Publication
(10) Pub. No.: US 2015/0335002 A1
(43) Pub. Date: Nov. 26, 2015

(54) TACKLE BOX WITH POLE SUPPORT

(71) Applicant: Stewart Andrews, West Richland, WA (US)

(72) Inventor: Stewart Andrews, West Richland, WA (US)

(21) Appl. No.: 14/283,519

(22) Filed: May 21, 2014

(51) Int. Cl. A01K 97/10; A01K 97/06

(52) U.S. Cl. CPC A01K 97/10; A01K 97/06

(57) ABSTRACT

A tackle box with pole support to maintain a fishing pole in an erect position comprising a tackle box, where the tackle box is divided between a top portion and a bottom portion; a rest attached to a side of the top portion of the tackle box, where the rest moves from a retracted position upward into an extended position to receive a rod of the fishing pole; a lock on the rest, where the lock secures the rest into the extended position; and an extendable support within the bottom portion of the tackle box, where the extendable support moves on a slide in and out of an opening in the bottom portion to brace a handle of the fishing pole while the rod is positioned within the rest.

### BACKGROUND OF THE INVENTION

1. Field of the Invention

The present invention relates to a tackle box that includes an extension to provide support and an anchor to a fishing pole.

2. Description of Related Art

Fishing is a fun recreational and sporting activity enjoyed by many people. Some prefer to fish for pleasure while others fish for sport. Fishermen have their preferred methods to fish, but a few concepts are common to all; utilizing a hook and a line to snare a fish. Even though the basic concept is simple, the techniques used have transformed fishing into what some consider an art form, with a preferred style for everyone. Also, the type, size and weight of the fish sought can determine the length, weight, flexibility, and speed of the rod.

While the sport is fun, there is often a lot of gear that must be carried and lugged to the fishing location. All of the equipment may get heavy causing transport to be difficult and cumbersome. Tackle boxes simplify having to carry individually pieces of gear, but they cannot carry the fishing rod. The user must separately hold the tackle box and pole to their desired fishing spot.

Additionally, while fishing the fisherman must continuously support and brace their pole until they reel in the line. For assistance, some people dig a small hole and burry a portion of the handle into the ground to hold the pole upright. Alternatively, pole holders are available to provide a resting spot upon which the fisherman may lay their pole. While these devices are helpful it adds yet another item that the user must lug around while fishing. Therefore it would be beneficial in the art to provide a way to support a fishing pole that doesn't require more cumbersome equipment that the user must carry.

### SUMMARY OF THE INVENTION

In view of the foregoing disadvantages inherent in the prior art, the general purpose of the present invention is to provide a tackle box with pole support to maintain a fishing pole in an erect position, configured to include all of the advantages of the prior art, and to overcome the drawbacks inherent therein.

Accordingly, an object of the present invention is to provide a tackle box with pole support that adds a fishing pole support to a tackle box to position the fishing pole upright.

Another object of the present invention is to provide a tack box with pole support that includes a rest that extends upward and a support that extends out, where both the rest and support brace the fishing pole during use.

To achieve the above objects, in an aspect of the present invention, a tackle box with pole support is described comprising a tackle box, where the tackle box is divided between a top portion and a bottom portion; a rest attached to a side of the top portion of the tackle box, where the rest moves from a retracted position upward into an extended position to receive a rod of the fishing pole; a lock on the rest, where the lock secures the rest into the extended position; and an extendable support within the bottom portion of the tackle box, where the extendable support moves on a slide in and out of an opening in the bottom portion to brace a handle of the fishing pole while the rod is positioned within the rest.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a tackle box with pole support in accordance with an exemplary embodiment of the present invention;

FIG. 2 depicts a perspective view of a tackle box with pole support in an extended position in accordance with an exemplary embodiment of the present invention;

FIG. 3 depicts a front view of a bottom portion of a tackle box with pole support in accordance with an exemplary embodiment of the present invention; and

FIG. 4 depicts a perspective view of a tackle box with pole support and a fishing pole in accordance with an exemplary embodiment of the present invention.

Like reference numerals refer to like parts throughout the description of several views of the drawings.

### DETAILED DESCRIPTION OF THE DRAWINGS

The present invention relates to a tackle box that includes an extension to provide support and an anchor to a fishing pole. The present invention provides a tackle box with pole support to combine a tackle box with a fishing pole holder into a single device. The tackle box includes an extendable support that braces a handle of a fishing pole against the box. An adjustable rest lifts from the top of the tackle box to secure the fishing pole and prevent falling or sliding during use. The tackle box with pole support eliminates having to stick the handle into the ground, and offers the user an easy to use and convenient way to relax while fishing.

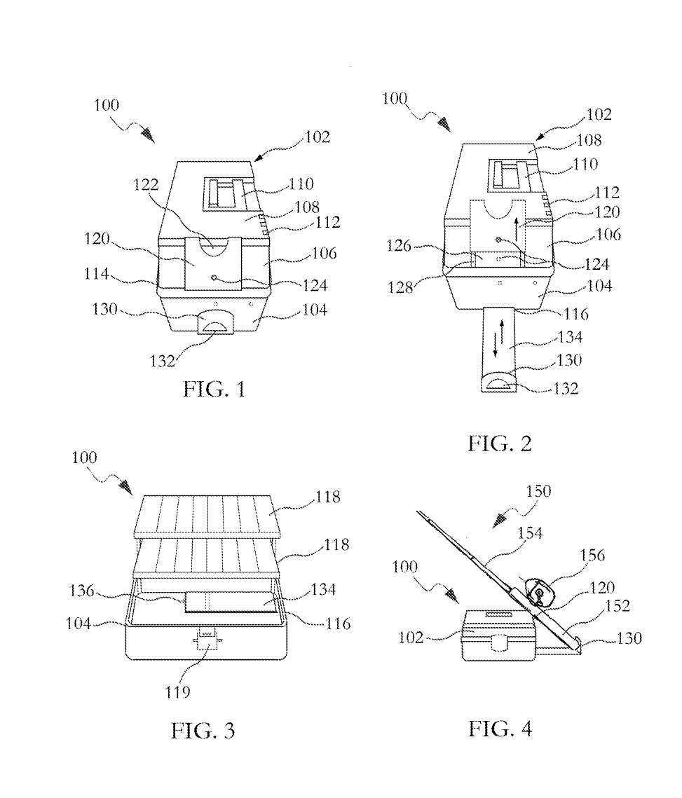

Turning now descriptively to the drawings, referring to FIG. 1, a perspective view of a tackle box with pole support 100 is shown in accordance with an exemplary embodiment of the present invention. The tackle box with pole support 100 includes a tackle box 102 divided between a bottom portion 104 and a top potion 106. The tackle box 102 further includes a lid 108 attached on a hinge 112 and a handle 110 to easily carry and transport the tackle box 102. The tackle box 102 may be generally plastic, and with filled with multiple shelves 118 (illustrated in FIG. 3) and storage compartments to receive all of the bait and accessories a fisherman may need. The tackle box 102 includes a closure 119 as illustrated in FIG. 3 to secure the top portion 106 against the bottom potion 104.

On a side 114 of the tackle box 102 a rest 120 is fastened against the top portion 106. The rest 120 includes a receiving portion 122 which accepts a rod of a fishing pole. The receiving portion 122 may be semicircular or square shaped to balance the rod while resting against the tackle box 102. The rest 120 moves against the side 114 up and down, and is secured into position with a lock 124. As illustrated, when in the storage position or retracted position, the rest 120 is flush against the lid 108 to prevent the rest 120 from catching on anything when not in use.

The bottom portion 104 of the tackle box 102 additionally includes an extendable support 130. The extendable support 130 slides in and out of the bottom portion 104 as needed to maintain the fishing pole in an upright position while resting against the rest 120. The extendable support 130 may include a support handle 132 to withdraw and insert the support 130 as needed.

Referring now to FIG. 2, a perspective view of the tackle box with pole support 100 in an extended position in accordance with an exemplary embodiment of the present invention. In the extended position the rest 120 raises above the lid 108 to enable the receiving portion to accept the rod. The rest 120 moves along a track 126 with a pair of lateral guides 128. The lock 124 secures the rest 120 at various heights along the track 126 to adjust the angle of the fishing pole while braced against the extendable support 130. The lock 124 includes at least two locking buttons to hold the rest 120 in at least one elevated position against the side 114. The extendable support 130 slides out of the bottom portion 104 on a slide 134. The slide 134 is received by an opening 116 within the tackle box 102.

Referring to FIG. 3, a front view of the bottom portion 104 is shown. The bottom portion 104 may include one or more trays 118 with storage to divide and organize all of the user's tools. The slide 134 moves within the bottom portion 104 in and out of the opening 116. At a far end of the slide 134 may be a stopper 136 to prevent the slide 134 from being completely removed from the bottom portion 104 when in the extended position.

Referring to FIG. 4 a perspective view of the tackle box with pole support 100 is shown with the fishing pole 150. During use, the user may pull support handle to withdraw the extendable support 130 to a maximum slide length. The handle 152 of the fishing pole 150 rests against the support handle. The top portion of the handle 152 or rod 154 is then placed within the rest 120 to brace the fishing pole 150 in an erect position. The rest 120 is adjusted so that the angle of the fishing pole is stable enough to maintain the erect position without sliding or falling. The reel 156 is placed above the rest 120 to prevent interference when reeling in a fish. With the fishing pole support 100 the user is provided a convenient tool offering the storage utility of a tackle box while also presenting a beneficial support device.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A tackle box with pole support to maintain a fishing pole in an erect position comprising:
a. a tackle box, where the tackle box is divided between a top portion and a bottom portion;
b. a rest attached to a side of the top portion of the tackle box, where the rest moves from a retracted position upward into an extended position to receive a rod of the fishing pole;
c. a lock on the rest, where the lock secures the rest into the extended position; and
d. an extendable support within the bottom portion of the tackle box, where the extendable support moves on a slide in and out of an opening in the bottom portion to brace a handle of the fishing pole while the rod is positioned within the rest.

2. The tackle box with pole support according to claim 1, where the tackle box includes a lid and a handle.

3. The tackle box with pole support according to claim 2, where the rest remains flush against the lid when in the retracted position.

4. The tackle box with pole support according to claim 1, where the rest includes a receiving portion to accept the rod and prevent it from sliding.

5. The tackle box with pole support according to claim 4, where the receiving portion is semicircular.

6. The tackle box with pole support according to claim 4, where the receiving portion is square.

7. The tackle box with pole support according to claim 1, where the rest is coupled to a track with a pair of lateral guides to move the rest between the retracted and extended positions.

8. The tackle box with pole support according to claim 1, where the lock includes at least two locking buttons to secure the rest into the extended position.

9. The tackle box with pole support according to claim 1, where the slide includes a stopper to prevent the slide from pulling out of the bottom portion.

10. The tackle box with pole support according to claim 1, where the extendable support includes a support handle to pull the slide from the lower portion.
